(19) United States
(12) Patent Application Publication
(10) Pub. No.: US 2025/0389343 A1
(43) Pub. Date: Dec. 25, 2025

(54) Electromagnet Flow Control Valve Where Fluid Flows Through the Electromagnet

(71) Applicant: SVM Schultz Verwaltungs-GmbH & Co. KG, Memmingen (DE)

(72) Inventors: Ralph Wassermann, Holzgünz (DE); Martin Kächler, Memmingen (DE)

(21) Appl. No.: 19/232,599

(22) Filed: Jun. 9, 2025

(30) Foreign Application Priority Data
Jun. 25, 2024 (DE) 102024117816.7

(51) Int. Cl. F16K 31/06; F16K 47/04

(52) U.S. Cl. CPC F16K 31/0651; F16K 47/04

(57) ABSTRACT

A flow control valve can include: a valve body having an inlet opening and an outlet opening on opposite sides of the body, and a fluid channel which fluidically connects the inlet opening to the outlet opening; an electromagnet penetrated by the fluid channel; and a sealing body that is adjustable between a closed position closing the fluid channel and an open position opening up the fluid channel. A method can include providing an armature with a longitudinal passage and a fixing groove on an inner circumferential side of the armature; providing an armature rod designed as a hollow part; inserting the armature rod into the longitudinal passage from a first side of the armature; inserting a deformation tool into the longitudinal passage from a second side of the armature; and moulding the armature rod into the fixing groove by the deformation tool.

### CROSS-REFERENCE TO RELATED APPLICATIONS

This non-provisional application claims the benefit of, and priority to, German Application No. 102024117816.7, filed on Jun. 25, 2024, which is incorporated by reference in its entirety.

### FIELD OF THE DISCLOSURE

The present disclosure relates to a flow control valve.

### BACKGROUND

Flow control valves, in particular electromagnetically actuatable flow control valves, are known in practice. The flow control valves have a channel through which a fluid can flow. However, the channels in the valve are usually deflected and/or the valve has a complicated design. In addition, flow control valves of this type are functionally limited.

### SUMMARY

A flow control valve can include: a valve body having an inlet opening and an outlet opening on opposite sides of the valve body, a fluid channel, which fluidically connects the inlet opening to the outlet opening; an electromagnet which is penetrated by the fluid channel; and a sealing body which is adjustable between a closed position closing the fluid channel and an open position opening up the fluid channel.

A method for mounting an armature rod can include: providing an armature with a longitudinal passage and a fixing groove on an inner circumferential side of the armature; providing an armature rod designed as a hollow part; inserting the armature rod into the longitudinal passage from a first side of the armature; inserting a deformation tool into the longitudinal passage from a second side of the armature; and moulding the armature rod into the fixing groove by the deformation tool.

### BRIEF DESCRIPTION OF THE DRAWINGS

Further features, details, and advantages of the invention can be gathered from the wording of the claims and also from the following description of exemplary embodiments with reference to the drawings, in which:

FIG. 1 shows a longitudinal section through a flow control valve;

FIG. 2a shows a perspective view of a sealing body;

FIG. 2b shows a longitudinal section through the sealing body from FIG. 2a;

FIG. 2c shows a detailed view from FIG. 2b;

FIG. 2d shows a further detailed view from FIG. 2b; and

FIG. 2e shows a front view of the sealing body.

### DETAILED DESCRIPTION

In the figures, like or corresponding elements are each denoted by like reference signs and therefore, if not expedient, are not described anew. In order to avoid repetition, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions according to the invention.

Disclosed is a flow control valve, through which a longitudinal axis passes, is therefore proposed, comprising a valve body having an inlet opening and an outlet opening on opposite sides of the valve body, and a fluid channel, which fluidically connects the inlet opening to the outlet opening, and an electromagnet, which is penetrated by the fluid channel, wherein the flow control valve comprises a sealing body which is adjustable between a closed position closing the fluid channel and an open position opening up the fluid channel.

The openings in the valve body are located on opposite sides or on the end faces of the valve body. The flow control valve is therefore an “in-line” flow control valve. The flow can pass axially along the longitudinal axis through the flow control valve, and therefore disadvantageous deflections of the fluid channel are avoided. The fluid channel is free from deflections and/or extends, preferably completely, along the longitudinal axis. It is therefore optimized in terms of flow and prevents undesired turbulence in the fluid. Such a flow control valve can be produced cost-effectively and requires the smallest installation space, because it can be installed in an optimally space-saving manner in a pipeline system. The fluid channel can extend, preferably continuously, from the inlet opening to the outlet opening. Fluid can pass through the fluid channel from the inlet opening to the outlet opening (fluid direction). This is used for the design as an “in-line” flow control valve. The inlet opening can have a cross section through which fluid can pass.

The electromagnet, in particular its coil, is penetrated by the fluid channel, and therefore the fluid can flow through the electromagnet, in particular its coil. This is used to cool the coil, because the fluid in the fluid channel optimally dissipates ohmic heat losses. The flow through the electromagnet also serves as an advantageous connection position and a compact design.

The flow control valve can be normally closed. The electromagnet can comprise a coil unit having a coil carrier and a coil, which can be selectively energized to generate a magnetic field for moving an armature along the longitudinal axis. The electromagnet can comprise an armature unit comprising the armature and an armature rod, which can be fixedly connected to the armature. The armature is movable in an armature chamber. The armature can have a longitudinal passage through which the fluid channel can extend. The longitudinal passage can, at least partially, delimit the channel on the outer circumferential side. The armature rod can have a longitudinal passage through which the fluid channel can extend. The armature rod can delimit the channel on the outer circumferential side, preferably over the full length of the longitudinal passage. This serves to avoid deflections of the fluid channel. The armature, the armature rod and the sealing body can be fixedly connected to one another and are jointly adjustable. This is used for the compact design and cost-effective production since such an assembly can be premanufactured. The electromagnet can comprise a core. The core can delimit the armature chamber on the end faces. The core can have a longitudinal passage through which the fluid channel can extend. The longitudinal passage can delimit the channel on the outer circumferential side. The coil can be energized to adjust the armature along the longitudinal axis and move the sealing body from its closed position into its open position. The sealing body can be returned into its closed position using the preloading means.

The sealing body can be connected to the armature or fastened thereto and/or can be adjustable therewith. The sealing body can then also be adjusted by electromagnetic adjustment of the armature. The sealing body can be adjustable parallel along the longitudinal axis between its positions. The sealing body can be located in the longitudinal passage of the armature and/or the armature rod. This serves to avoid deflections of the fluid channel. The sealing body can be free from undercuts in the longitudinal direction. This serves to avoid turbulence and/or for the cost-effective production.

The flow control valve can form a sealing seat against which the sealing body can sealingly bear in its closed position. The sealing seat can be formed at the inlet opening, this serving for a compact design.

According to a development of the flow control valve, the sealing body can be arranged, preferably entirely, in the fluid channel. This serves for a compact design. Fluid can be flushed around the sealing body on the outer circumferential side in the fluid channel, preferably in the longitudinal direction. This serves to avoid turbulence.

According to a development of the flow control valve, the sealing body can be made of plastics material or metal. The plastics material can be a thermoplastic or thermosetting material. Owing to its good sliding properties, it is suitable for reducing frictional resistance during the adjustment. Furthermore, it has no effect on the magnetic circuit of the electromagnet. If the sealing body forms a sealing surface itself, the elasticity of plastic serves for advantageous tightness in the closed position. The metal may be steel or brass. Steel has the advantage of a low coefficient of thermal expansion and thus a low temperature-dependent drift of the flow characteristic curve. Steel enables precise production tolerances and results in low scatter. The wear of the steel at the sealing seat is also low. Brass affords good sliding properties, in particular in combination with plastic as a sliding partner. It is conceivable for the sealing body to be made of steel or brass and for its sliding partner, preferably the valve body, to be made of the other one of steel or brass in the region of contact with the sealing body.

It is conceivable for the sealing body to be an injection-moulded part, a sintered part or an additively produced part. Injection moulding is cost-effective, in particular when the sealing body is free from undercuts in the longitudinal direction. A sintered part is resistant to diverse fluids and is also thermally stable. It also affords great freedom of shaping, since sintering permits complex geometries and individual shapes, which makes the design of sealing bodies more flexible. An additively produced part, for example by means of 3D printing, can also realize a complex geometry at simultaneously low cost.

According to a development of the flow control valve, the sealing body on its outer circumferential side can form at least one longitudinal channel. Preferably, the sealing body forms a plurality of longitudinal channels on its outer circumferential side, preferably evenly spaced apart in the circumferential direction. The longitudinal channel/the longitudinal channels can form part of the fluid channel. The longitudinal channel/the longitudinal channels can extend parallel, preferably strictly parallel, along the longitudinal axis. This avoids turbulence. The longitudinal channel/the longitudinal channels can be open on the end faces. This can take account of the freedom from deflections.

It is conceivable for the sealing body to comprise a central mandrel and longitudinal ribs arranged on the outer circumferential side of the central mandrel. A longitudinal channel can be formed between adjacent longitudinal ribs. The longitudinal ribs are advantageously located on the sealing body, since they can be produced cost-effectively there. Each longitudinal rib protrudes radially from the central mandrel and extends parallel, preferably strictly parallel, along the longitudinal axis. This avoids turbulence. The central mandrel can extend along the longitudinal axis.

It is conceivable for the sealing body to be integral, preferably made of one material. The sealing body can thereby be produced cost-effectively. Furthermore, it is durable since connecting points between sections of the sealing body are avoided. The central mandrel can be formed integrally with the longitudinal ribs.

It is conceivable for the longitudinal ribs on the approach-flow side to each have an increasing radial height in the longitudinal direction. This region can be referred to as the rising region. As a result, the fluid does not flow against a vertical wall, thus avoiding turbulence.

It is conceivable for the longitudinal ribs on the discharge side to each have a mounting stop. This allows an installation depth of the sealing body in the armature to be reliably determined, as a result of which outlay on installation is reduced. It is conceivable for the armature on the inner circumferential side to have an annular mounting step against which the mounting stops can bear. For reasons of low-complexity geometry, the longitudinal ribs on the discharge side can each have an end face extending perpendicular to the longitudinal axis, said end face forming the mounting stop.

It is conceivable for the side walls of the longitudinal ribs to be aligned with the longitudinal axis, as viewed cross sectionally. As a result, the longitudinal ribs can be narrower in the circumferential direction of the central mandrel than on the outer circumferential side. This also permits a large flow region (narrow ribs on the central mandrel) and a large guide/fastening surface (wide ribs on the outer circumferential side).

It is conceivable for the sealing body to be pressed into the armature. This makes it possible to achieve a cost-effective and durable fastening. The press connection can be made by means of the fastening surface. In addition. or alternatively, it is conceivable for the sealing body to be fastened and/or secured to the armature by means of a snap ring and/or crimping and/or adhesive bonding and/or welding. Advantageously, in addition to the press connection, a sealing body made of a plastics material can be fastened to the armature by means of further fastening/securing. This can avoid radial play due to different coefficients of thermal expansion of the plastic of the sealing body and the metal of the armature. A sealing body made of metal can be advantageously fastened to the armature by means of just one fastening. Different coefficients of thermal expansion can be ignored.

According to a development of the flow control valve, the sealing body on its outer circumferential side can have a guide surface and a fastening surface, which preferably differs therefrom. The guide surface and/or fastening surface can be formed by the longitudinal ribs. This permits deep longitudinal channels in the radial direction, which each allow a large throughflow capacity. The guide surface can bear in a guiding manner against a component surrounding the outer circumferential side of the sealing body, for example against the valve body. The guiding contact avoids magnetic transverse tension and serves for the optimum concentricity of the sealing body and sealing seat. The fastening surface can bear in a manner fastened against a component surrounding the outer circumferential side of the sealing body, for example against the armature. The inner circumferential surface of the armature and the fastening surface can bear directly against each other.

It is conceivable for the guide surface to be arranged upstream of the fastening surface. (Upstream with respect to the fluid direction). The guide surface and the fastening surface are arranged adjacent to each other in the longitudinal direction. This means that the sealing body can be fastened in the armature by means of the fastening surface and can protrude with the guide surface from the armature on the end face. This serves for the compact design. It is conceivable for the sealing body to protrude through a transverse plane, wherein the guide surface, but not the fastening surface, is arranged on the one side of the transverse plane, and the fastening surface, but not the guide surface, is arranged on the other side of the transverse plane. This allows a simple geometric separation of the surfaces, resulting in low complexity.

According to a development of the flow control valve, the sealing body can have two sections of different outer diameter, wherein the guide surface is located on the section of smaller outer diameter and the fastening surface is located on the section of larger outer diameter. The two sections can be formed by the longitudinal ribs. The two sections can directly adjoin each other in the longitudinal direction. This serves for the compactness in the longitudinal direction. A diameter jump can be formed between the two sections. The section of larger outer diameter allows a large throughflow in said section while simultaneously being press-connected to the armature.

It is conceivable for the radial length of the longitudinal ribs to be in the range of 0.25 to 2.0 times the diameter of the throughflow cross section of the inlet opening, preferably 1.0 times. The radial length can be measured perpendicular to the longitudinal axis and/or between the outer circumferential surface of the central mandrel and the outer circumferential surface of the longitudinal rib. The outer circumferential surface of the longitudinal rib can define the largest outer diameter of the sealing body.

It is conceivable for the radial length or first radial length of the longitudinal ribs in the section of the sealing body of smaller outer diameter to be in the range of 0.25 to 2.0 times the diameter of the through-flowable cross section of the inlet opening, preferably 0.5 times. It is conceivable for the radial length or second radial length of the longitudinal ribs in the section of the sealing body of larger outer diameter to be in the range of 0.25 to 2.0 times the diameter of the through-flowable cross section of the inlet opening, preferably 0.75 times.

It is conceivable for the largest outer diameter of the sealing body to be in the range of 1.5 to 4.0 times the diameter of the through-flowable cross section of the inlet opening, preferably 2.8 times. It is conceivable for the outer diameter of the sealing body in the section of the sealing body of smaller outer diameter to be in the range of 1.5 to 3.5 times the diameter of the through-flowable cross section of the inlet opening, preferably 2.2 times. It is conceivable for the outer diameter in the section of the sealing body of larger outer diameter to be in the range of 2.0 to 4.0 times the diameter of the through-flowable cross section of the inlet opening, preferably 2.8 times.

Alternatively, it is conceivable for the longitudinal ribs have a constant outer diameter along the longitudinal axis. Apart from the increasing radial height (rising region), if present. This enables geometry simplification to be achieved.

According to a development of the flow control valve, the sealing body on the approach-flow side can have a dynamic pressure reduction section, and/or can have a convexly and/or concavely and/or linearly shaped characteristic curve adjustment section, and/or can have a sealing section, and/or can have a discharge section. The section/the sections can be formed by the central mandrel. The approach-flow side faces the inlet opening, the discharge side faces the outlet opening. The sections can be arranged concentrically to each other and/or successively in the fluid direction, preferably in the specified sequence. Two sections can preferably be arranged directly successively in the fluid direction.

The dynamic pressure reduction section can have a tip and, starting from the latter, an outer diameter increasing in the fluid direction. At the dynamic pressure reduction section, the stagnation point of the fluid can form. For example, the dynamic pressure reduction section can be conical. The dynamic pressure reduction section breaks up the dynamic pressure of the fluid, resulting in advantageous flow characteristics.

As viewed in longitudinal section, the outer circumferential surface of the dynamic pressure reduction section can enclose an angle or first angle in the range of 20° to 30°, preferably of 25°, with the longitudinal axis.

The length of the dynamic pressure reduction section (or first length of the sealing body) can be in the range of 0.4 to 0.6 times the diameter of the through-flowable cross section of the inlet opening, preferably 0.5 times. The length can be measured parallel to the longitudinal axis.

The largest diameter of the dynamic pressure reduction section (or first diameter of the sealing body) can be in the range of 0.4 to 0.6 times the diameter of the through-flowable cross section of the inlet opening, preferably 0.5 times.

The dynamic pressure reduction section can enclose an angle or second angle with the section of the sealing body or central mandrel immediately adjoining downstream. The characteristic curve adjustment section can enclose an angle or second angle with the section of the sealing body or central mandrel immediately adjoining upstream. The angle or second angle can be enclosed by the dynamic pressure reduction section and characteristic curve adjustment section. The angle or second angle can be in the range of 140° to 179°, preferably 150°. These geometrical ratios serve for fluid flow free from turbulence.

The convex, concave and linear profile of the characteristic curve adjustment section is viewed in longitudinal section. The characteristic curve adjustment section can have sub-regions of differently shaped profiles (convex, concave, linear). The sub-regions can be arranged adjacent to one another in the fluid direction. The convex and/or concave characteristic curve adjustment section can consist of a plurality of mutually directly adjacent linear curves, preferably of three linear curves. The linear gradients can be inclined differently with respect to the longitudinal axis. Between these adjacent linear curves, rounded sections can be formed, as viewed in longitudinal section. The radius/radii of the rounded sections can be R0.2 and/or in the range of 0.05 to 2.5 times the diameter of the through-flowable cross section of the inlet opening. This serves to reduce a flow separation.

The characteristic curve adjustment section can be annular and serves for the structural adjustment of the characteristic curve shape and stroke/throughflow characteristic curve. A convexly shaped characteristic curve adjustment section bulges out of the sealing body, while a concavely shaped characteristic curve adjustment section represents an indentation on the sealing body. By means of the shape of the characteristic curve adjustment section, the through-flowable cross-sectional area can be adjusted depending on the adjustment distance of the sealing body. A progressive characteristic curve shape (characteristic curve of fluid mass flow over electrical control current for the electromagnet) can be achieved by means of a convexly shaped characteristic curve adjustment section. By contrast, a degressive characteristic curve shape (characteristic curve of fluid mass flow over electrical control current for the electromagnet) can be achieved by means of a concavely shaped characteristic curve adjustment section. A linear characteristic curve shape (characteristic curve of fluid mass flow over electrical control current for the electromagnet) can be obtained by means of a linearly shaped characteristic curve adjustment section. The characteristic curve shape and/or the starting point of the characteristic curve can advantageously now be influenced/adjusted by an appropriately geometric configuration of the sealing body. The characteristic curve can have degressive, linear and/or progressive sections.

As viewed in longitudinal section, the outer circumferential surface of the characteristic curve adjustment section can enclose an angle or third angle in the range of 125° to 165°, preferably of 145°, with the longitudinal axis. In addition, or alternatively, as viewed in longitudinal section, the outer circumferential surface of the characteristic curve adjustment section can enclose an angle or fourth angle in the range of 1° to 20°, preferably of 5°, with the longitudinal axis. It is precisely by means of this angle that the design can influence the slope of the characteristic curve. The smaller this angle is, the less the characteristic curve changes along the sealing body stroke.

The length of the characteristic curve adjustment section (or second length of the sealing body) can be in the range of 0.4 to 0.8 times the diameter of the through-flowable cross section of the inlet opening, preferably 0.5 times. The length can be measured parallel to the longitudinal axis.

The largest diameter of the characteristic curve adjustment section (or second diameter of the sealing body) can be in the range of 0.8 to 0.95 times the diameter of the through-flowable cross section of the inlet opening, preferably 0.9 times.

The characteristic curve adjustment section can enclose an angle or fifth angle with the section of the sealing body or central mandrel immediately adjoining downstream. The sealing section can enclose an angle or fifth angle with the section of the sealing body or central mandrel immediately adjoining upstream. The angle or fifth angle can be enclosed by the characteristic curve adjustment section and sealing section. The angle or fifth angle can be in the range of 140° to 179°, preferably 155°. These geometrical ratios serve for fluid flow free from turbulence.

In the closed position, the sealing section bears sealingly against the sealing seat. The sealing section can be annular and/or have an outer diameter increasing in the fluid direction. This allows dimensional tolerances and changes in geometry during operation to be compensated for and a tight contact against the sealing seat to be realized. For example, the sealing section can be conical.

As viewed in longitudinal section, the outer circumferential surface of the sealing section can enclose an angle or sixth angle in the range of 15° to 35°, preferably of 25°, with the longitudinal axis. This results in secure sealing while simultaneously preventing jamming due to an excessively sharp angle and at the same time allowing flow free from turbulence.

The length of the sealing section (or third length of the sealing body) can be in the range of 0.10 to 0.4 times the diameter of the through-flowable cross section of the inlet opening, preferably 0.25 times. The length can be measured parallel to the longitudinal axis.

The largest diameter of the sealing section (or third diameter of the sealing body) can be in the range of 1.05 to 1.5 times the diameter of the through-flowable cross section of the inlet opening, preferably 1.25 times.

The sealing section can enclose an angle or seventh angle with the section of the sealing body or central mandrel immediately adjoining downstream. The discharge section can enclose an angle or seventh angle with the section of the sealing body or central mandrel immediately adjoining upstream. The angle or seventh angle can be enclosed by the sealing section and the discharge section. The angle or seventh angle can be in the range of 140° to 179°, preferably 155°. These geometrical ratios serve for fluid flow free from turbulence.

The discharge section can be connected to the sealing section in the fluid direction and/or have a decreasing outer diameter in the fluid direction. It leads to a lowest possible pressure loss in the fluid and avoids undesired turbulence. It is conceivable for the discharge section to be formed in two parts and to have a cylinder section arranged upstream and an outer diameter reduction section arranged downstream. The sections can directly adjoin each other. The outer diameter can taper in the fluid direction. It is advantageous that the longitudinal ribs end at the cylinder section, this serving for a compact design with a simultaneously largest possible guide surface. As viewed in longitudinal section, the outer circumferential surface of the cylinder section can run parallel to the longitudinal axis.

As viewed in longitudinal section, the outer circumferential surface of the cylinder section can enclose an angle or eighth angle in the range of 2° to 15°, preferably of 7°, with the outer circumferential surface of the outer diameter reduction section. This leads to the avoidance of turbulence. As viewed in longitudinal section, the outer circumferential surface of the outer diameter reduction section can enclose an angle or ninth angle in the range of 2° to 15°, preferably of 6°, with the longitudinal axis. This leads to the avoidance of turbulence.

The length of the discharge section (or fourth length of the sealing body) can be in the range of 1.0 to 2.0 times the diameter of the through-flowable cross section of the inlet opening, preferably 1.5 times. The length can be measured parallel to the longitudinal axis. The length of the cylinder section can be in the range of 0.2 to 0.8 times the diameter of the through-flowable cross section of the inlet opening, preferably 0.5 times. The length can be measured parallel to the longitudinal axis. The length of the outer diameter reduction section can be in the range of 0.5 to 3.0 times the diameter of the through-flowable cross section of the inlet opening, preferably 1.0 times. The length can be measured parallel to the longitudinal axis. The lengths of the cylinder section and the outer diameter reduction section can produce the length of the discharge section.

The largest diameter of the discharge section (or fourth diameter of the sealing body) can be in the range of 1.0 to 1.5 times the diameter of the through-flowable cross section of the inlet opening, preferably 1.2 times. The largest diameter of the discharge section can be identical to the largest diameter of the sealing section.

The discharge section can enclose an angle or tenth angle with the section of the sealing body or central mandrel immediately adjoining downstream. The angle or tenth angle can be enclosed by the discharge section and a central base section of the central mandrel. The angle or tenth angle can be in the range of 2° to 15°, preferably 7°. These geometrical ratios serve for fluid flow free from turbulence.

The advantageous combination of all four sections serves for optimum loss minimization. Owing to the dynamic pressure reduction section, the characteristic curve adjustment section and the sealing section, the stagnation point flow can be virtually loss-free. The stagnation point flow can be followed by the wake flow which, because of the discharge section, is now no longer associated with losses, since vortex formation and a wake depression are avoided.

It is conceivable for the central mandrel to have a central base section. Preferably, the outer circumferential surface of the central base section, as viewed in longitudinal section, runs parallel to the longitudinal axis, preferably continuously. The central base section can be arranged downstream and/or adjacent, preferably directly adjacent, to the discharge section. The central base section can be arranged upstream and/or adjacent, preferably directly adjacent, to the nozzle needle. The central base section can serve for the stability of the sealing body.

The length of the central base section (or fifth length of the sealing body) can be in the range of 3 to 10 times the diameter of the through-flowable cross section of the inlet opening, preferably 6.0 times. The length can be measured parallel to the longitudinal axis.

The largest diameter of the central base section (or fifth diameter of the sealing body) can be in the range of 0.75 to 1.5 times the diameter of the through-flowable cross section of the inlet opening, preferably 1.0 times.

The central base section can enclose an angle or eleventh angle with the section or part of the sealing body or central mandrel immediately adjoining downstream. A nozzle needle can enclose an angle or eleventh angle with the section of the sealing body or central mandrel immediately adjoining upstream. The angle or eleventh angle can be enclosed by the central base section and the nozzle needle. The angle or eleventh angle can be in the range of 140° to 179°, preferably 165°. These geometrical ratios serve for fluid flow free from turbulence.

According to a development of the flow control valve, the sealing body can have a nozzle needle on the discharge side. The nozzle needle can be formed by the central mandrel. The nozzle needle can have an outer diameter decreasing in the fluid direction. It is used to avoid a negative pressure zone directly behind the sealing body that reduces the mass flow and exerts a disturbing force on the control function (magnetic force vs. flow force). The nozzle needle reduces the pressure loss in the flow cross section because the flow lines behind the sealing body are continuously merged. In addition, vortices detaching from the sealing body are avoided.

As viewed in longitudinal section, the outer circumferential surface of the nozzle needle can enclose an angle or twelfth angle in the range of 5° to 25°, preferably of 15°, with the longitudinal axis. This results in a turbulence-free merging of the fluid downstream of the sealing body.

The length of the nozzle needle (or sixth length of the sealing body) can be in the range of 0.6 to 2.6 times the diameter of the through-flowable cross section of the inlet opening, preferably 1.5 times. The length can be measured parallel to the longitudinal axis. It is conceivable for the nozzle needle to protrude from the longitudinal ribs along the longitudinal axis by a length or seventh length of the sealing body, which is in the range of 0.75 to 1.75 times the diameter of the through-flowable cross section of the inlet opening, preferably 1.15 times.

The largest diameter of the nozzle needle (or sixth diameter of the sealing body) can be in the range of 0.75 to 1.5 times the diameter of the through-flowable cross section of the inlet opening, preferably 1.0 times. The largest diameter of the nozzle needle can be identical to the largest diameter of the central base section.

The length of the longitudinal ribs (or eighth length of the sealing body) can be in the range of 4 to 10 times the diameter of the through-flowable cross section of the inlet opening, preferably 7.5 times. The length can be measured parallel to the longitudinal axis. The length or a ninth length of the sealing body or of the central mandrel can be in the range of 5 to 15 times the diameter of the through-flowable cross section of the inlet opening, preferably 10.0 times. The length can be measured parallel to the longitudinal axis.

According to a development of the flow control valve, it can comprise a bearing ring against which a preloading means is supported. The bearing ring can be stationary with respect to the valve body and/or the core, preferably by means of support of the preloading means and/or contact against an adjusting sleeve. The support and/or contact secures the axial position of the bearing ring. The bearing ring can define a support for the preloading means. With its selectable installation depth, the preloading of the preloading means and thus also a zero point of the flow/current characteristic curve can be adjusted. The bearing ring can be fastened in and/or to the longitudinal passage of the core. The bearing ring can be fastened in and/or to a bearing sleeve of the electromagnet. The bearing ring can have a longitudinal passage through which the fluid channel can run, this serving to avoid deflections. The bearing ring can be a separate part from the core. This allows it to be moved relative to the core during assembly in order to adjust the installation depth.

It is conceivable for the bearing ring to support the armature rod. The armature rod can reach through the longitudinal passage of the bearing ring and thus be guided on its outer circumferential side in the bearing ring when being adjusted in the longitudinal direction. This serves for a compact design, in particular with regard to a functional integration in the bearing ring (support for preloading means, adjustment means for the characteristic curve, mounting of the armature rod).

It is conceivable for the valve to comprise an adjusting sleeve which bears against the bearing ring. The adjusting sleeve can be fastened in and/or to the longitudinal passage of the core. The adjusting sleeve can have a longitudinal passage through which the fluid channel can run, this serving to avoid deflections. The longitudinal passage can delimit the fluid channel on the outer circumferential side. The adjusting sleeve is used for axial positioning of the bearing ring during assembly. The armature rod can engage in the adjusting sleeve, at least in the opening position. This allows a compact design to be achieved.

It is conceivable for the preloading means to be a helical spring, which is supported at one end on the bearing ring. At the other end, the preloading means can be supported on the armature or the armature rod. The preloading means can preload the sealing body into its closed position. With the selectable installation depth of the bearing ring, the preloading of the preloading means and thus also the (normally open) opening point of the sealing body can be adjusted.

According to a development of the flow control valve, the electromagnet can comprise the armature rod, which is designed as a hollow part and/or has a wall thickness in the range of 0.2 mm to 0.6 mm, preferably of 0.4 mm. The armature rod can be open on both end faces. As a result, the flow can pass completely through it in the longitudinal direction, thus avoiding deflections of the fluid channel. The wall thickness serves to maximize the through-flowable cross section and minimize flow losses.

It is conceivable for the armature rod to have at least one opening to the armature chamber. Through this at least one opening, the fluid channel can be fluidically connected directly to the armature chamber. This connection serves for fluidic compensation when the armature is adjusted.

It is conceivable for the armature rod to be arranged on the inner circumferential side of the preloading means. This serves for a compact design.

According to a development of the flow control valve, the armature of the electromagnet on the inner circumferential side can form a fixing groove in which the armature rod engages, preferably an axial edge of the armature rod engages in the fixing groove so as to form a tapering inner diameter. The inner diameter of the axial edge of the armature rod can taper along the fluid direction. The axial edge of the armature rod can be a moulded edge. Plastic deformation of the axial edge of the armature rod into the fixing groove affords several advantages. The armature rod is securely and permanently fastened to the armature. The tapering inner diameter reduces turbulence and avoids diameter jumps that lead to turbulence. The fixing groove can be arranged in the longitudinal passage of the armature. The positioning serves for the compact design, because the fastening can be carried out inside the armature. The fixing groove can be an annular groove. The ring shape serves for error-free mounting, since the alignment of the fixing groove with the armature rod is irrelevant. The fixing groove can be open to the inside radially, which serves for easy assembly and moulding.

It is conceivable for the armature rod to be pressed into the armature, preferably in its longitudinal passage. This makes it possible to achieve a cost-effective and durable fastening.

According to the disclosure, a method for mounting an armature rod is also proposed, comprising the following steps:
providing an armature with a longitudinal passage and a fixing groove on the inner circumferential side,
providing an armature rod, which is designed as a hollow part,
inserting the armature rod into the longitudinal passage from a first side of the armature,
inserting a deformation tool into the longitudinal passage from a second side of the armature,
moulding the armature rod into the fixing groove by means of the deformation tool.

The advantages already described above with regard to the flow control valve are also afforded for the method to which reference is hereby made. The armature rod can be the armature rod already described above. The same can be true of the armature. The method enables simple and cost-effective fastening of the armature rod as a hollow part in the armature. The two sides of the armature can be the two end faces of the armature. Thus, while the armature rod is inserted into the armature from the one side, the deformation tool is inserted into the armature from the other side. The tapering inner diameter can be formed by the moulding.

Should components be disclosed more than once, refinements and advantages that are described only for one of the components are considered to be disclosed optionally also for the other corresponding components.

The advantages described are particularly apparent in the aforementioned range boundaries, but the advantages can also be present beyond one or both specific range boundaries, even if only in a weakened form.

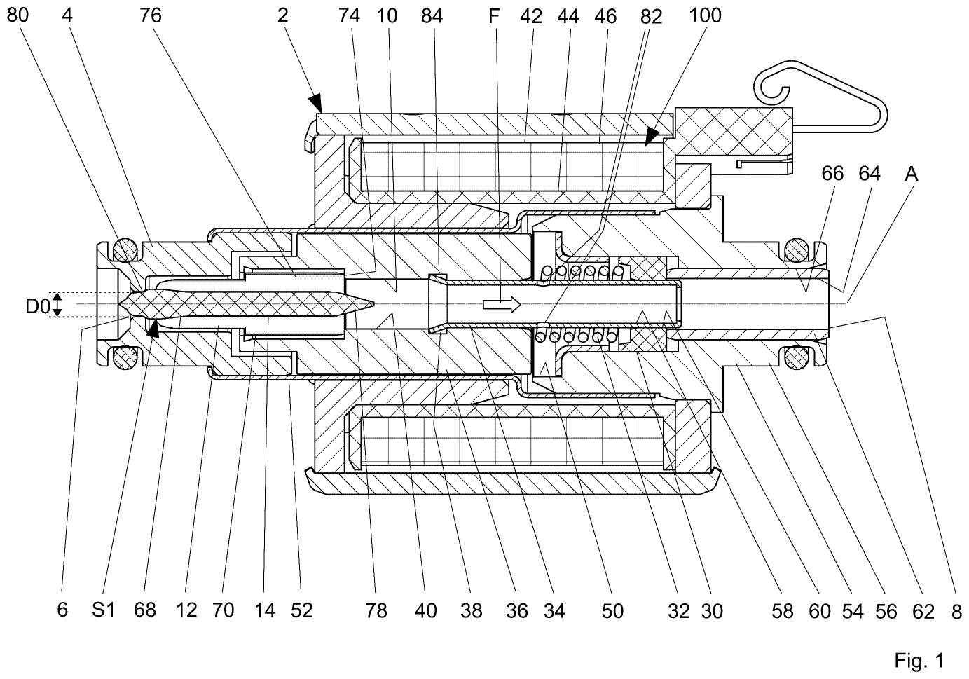

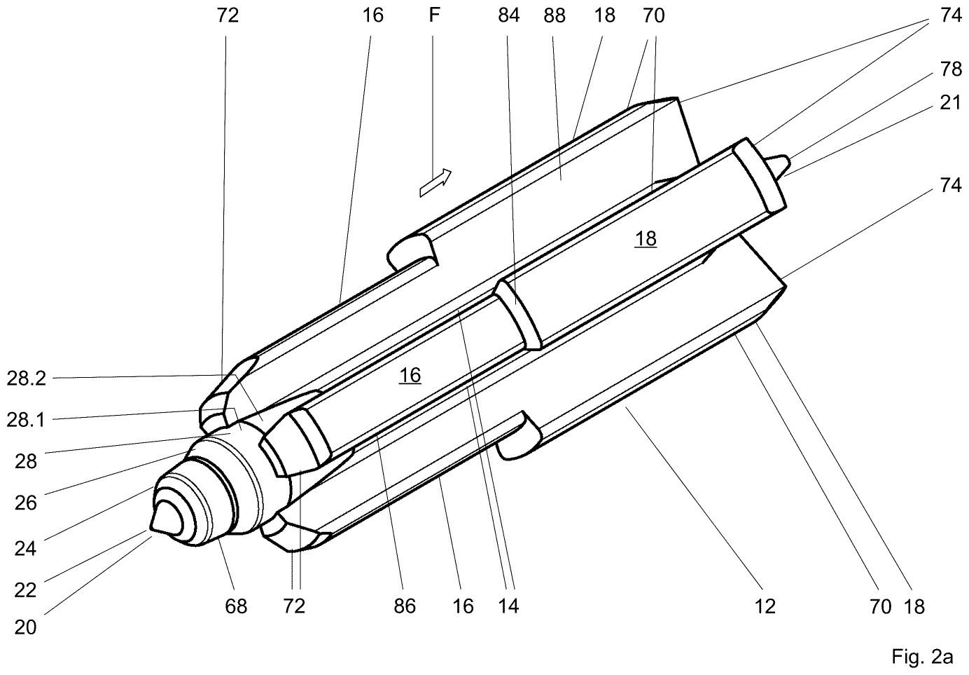

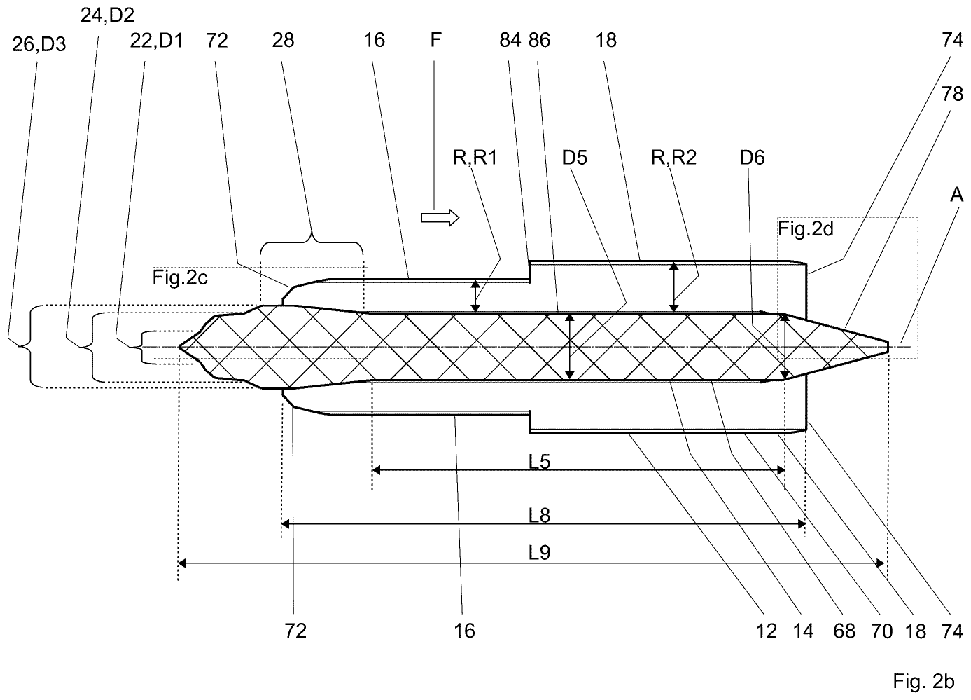

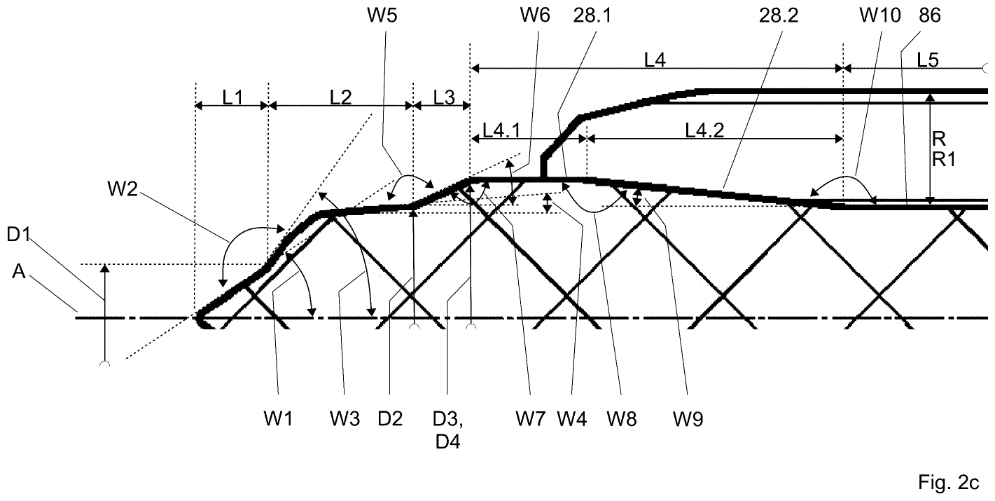

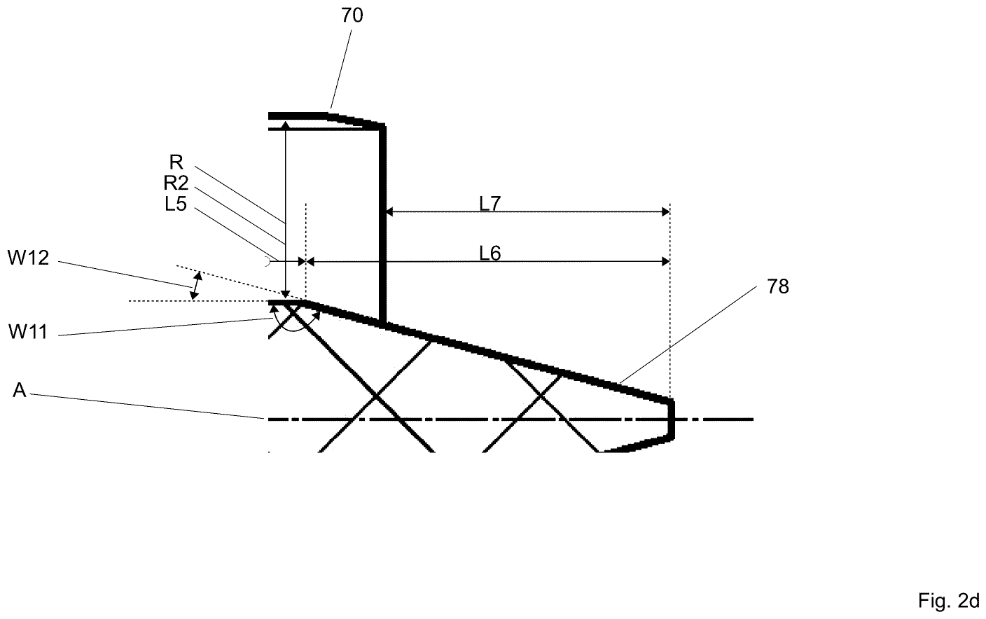

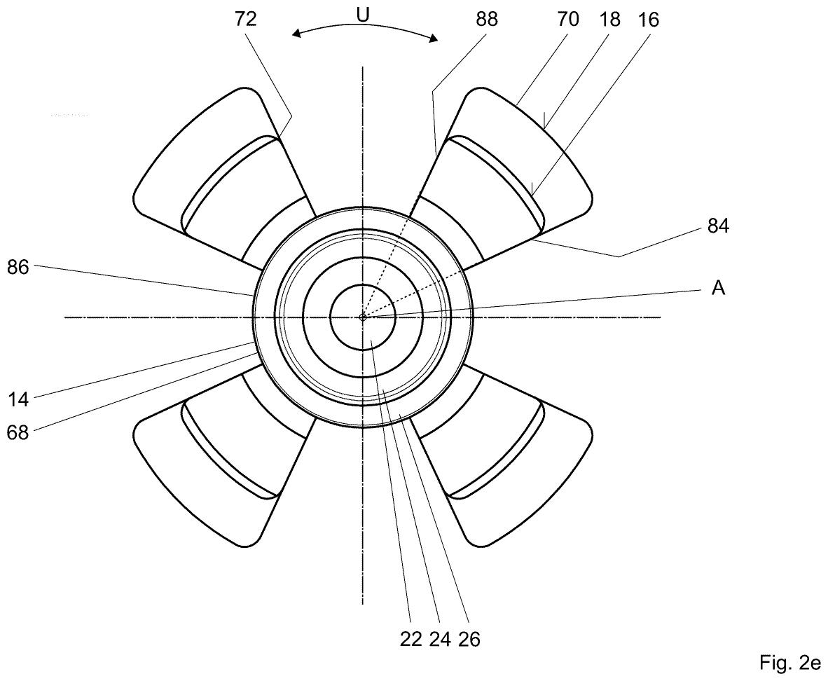

FIG. 1 shows a longitudinal section through a flow control valve 2. FIG. 2a, FIG. 2b, FIG. 2c, FIG. 2d, and FIG. 2e shows various views of a sealing body for the flow control valve 2 of FIG. 1. Description is made with reference to the figures.

The flow control valve 2 is passed through by a longitudinal axis A and comprises a valve body 4. The valve body 4 has, on its opposite end faces, an inlet opening 6 and an outlet opening 8. The inlet opening 6 comprises a cross section DO through which a fluid can pass. These two openings 6, 8 are connected by means of a fluid channel 10. Fluid can flow through the fluid channel 10 along a fluid direction F. The fluid channel 10 can be opened and is closable by adjustment of a sealing body 12. For this purpose, the sealing body 12 is adjustable between a closed position S1 closing the fluid channel 10 and an open position opening up the fluid channel 10. The flow control valve 2 forms a sealing seat 80 against which the sealing body 12 can sealingly bear in its closed position S1.

The flow control valve 2 comprises an electromagnet 100. The electromagnet 100 has a coil unit 42 having a coil carrier 44 and a coil 46. The coil 46 can optionally be energized in order to generate a magnetic field for moving an armature 36 along the longitudinal axis A. The electromagnet 100 furthermore comprises an armature unit 48, comprising the armature 36 and an armature rod 34, which is fixedly connected to the armature 36. The armature 36 is movable in an armature chamber 50, which is delimited by a bearing sleeve 52. The electromagnet 100 also has a core unit 54 having a core 56, the core 56 delimiting the armature chamber 50 on the end face. A bearing ring 30 is fastened in the core 56, the bearing ring 30 being a separate part with respect to the core 56. An adjusting sleeve 62 is fastened in the core 56, which bears against the bearing ring 30. The electromagnet 100 is penetrated by the fluid channel 10.

The armature 36, the armature rod 34 and the sealing body 12 are fixedly connected to one another and are adjustable together by the coil 46 being energized. The resetting is carried out by a preloading means 32. The adjustment is carried out parallel along the longitudinal axis A.

The fluid channel 10 runs between the inlet opening 6 and the outlet opening 8 through longitudinal passages of various components. The armature 36 has a longitudinal passage 40, through which the fluid channel 10 runs, the longitudinal passage 40 partially delimiting the fluid channel 10 on the outer circumferential side. The armature rod 34 has a longitudinal passage 58 through which the fluid channel 10 runs, the armature rod 34 delimiting the fluid channel 10 on the outer circumferential side, namely over the complete length of the longitudinal passage 58. The bearing ring 30 has a longitudinal passage 60 through which the fluid channel 10 runs. The adjusting sleeve 62 has a longitudinal passage 64 through which the fluid channel 10 runs, the longitudinal passage 64 delimiting the fluid channel 10 on the outer circumferential side. The core 56 has a longitudinal passage 66 through which the fluid channel 10 runs.

It can therefore be seen that the flow can pass axially along the longitudinal axis A through the flow control valve 2, and therefore disadvantageous deflections of the fluid channel 10 are avoided. The fluid channel 10 is free from deflections and extends completely along the longitudinal axis A.

The preloading means 32 is supported against the bearing ring 30. The bearing ring 30 is stationary with respect to the valve body 4 and the core 56 and axially secured to the core 56 by means of a press connection. The bearing ring 30 can be fastened in and to the longitudinal passage 66 of the core 56. The bearing ring 30 supports the armature rod 34. The preloading means 32 is illustrated here as a helical spring, which is supported at one end on the bearing ring 30 and is supported at the other end on the armature 36. The preloading means 32 preloads the sealing body 12 into its closed position S1. The adjusting sleeve 62 is fastened in and to the longitudinal passage 66 of the core 56.

The armature rod 34 is a hollow part and has a wall thickness in the range of 0.2 mm to 0.4 mm. It is open at both of its end faces and the flow can pass through it completely in the longitudinal direction. The armature rod 34 has two openings 82 to the armature chamber 50. The fluid channel 10 is fluidically connected directly to the armature chamber 50 by said openings 82. The armature rod 34 is arranged on the inner circumferential side of the preloading means 32. On the approach-flow side, the armature rod 34 has an axial edge 84 which is plastically moulded into a fixing groove 38 so as to form an inner diameter tapering along the fluid direction F. The fixing groove 38, which is designed as an annular groove, is open inwards radially and formed in the longitudinal passage 40 of the armature 36.

The sealing body 12 is integrally formed from one material from a central mandrel 68, which extends along the longitudinal axis A, and longitudinal ribs 70 arranged on the outer circumferential side of the central mandrel 68. On the discharge side, the sealing body 12 has a nozzle needle 78, which is formed by the central mandrel 68. The nozzle needle 78 has an outer diameter decreasing in the fluid direction F. The sealing body 12 is free from undercuts in the longitudinal direction.

A respective longitudinal channel 14 is formed between adjacent longitudinal ribs 70. Each longitudinal rib 70 protrudes from the central mandrel 68 in the radial direction and extends strictly parallel along the longitudinal axis A. The longitudinal ribs 70 and longitudinal channels 14 are uniformly distributed over the circumference of the central mandrel 68. The longitudinal channels 14 form part of the fluid channel 10 and are open on the end faces on both sides. On the approach-flow side, each longitudinal rib 70 has a radial height increasing in the longitudinal direction, said region being a rising region 72. On the discharge side, each longitudinal rib 70 has a mounting stop 74, which bears against an annular mounting step 76 of the armature 36. On the discharge side, the longitudinal ribs 70 each have an end face which runs perpendicular to the longitudinal axis A and forms the mounting stop 74.

The sealing body 12 has a guide surface 16 on its outer circumferential side and a fastening surface 18 differing therefrom. The guide surface 16 and the fastening surface 18 are formed by the longitudinal ribs 70. The sealing body 12 has two sections of different outer diameter, wherein the guide surface 16 is located on the section of smaller outer diameter and the fastening surface 18 is located on the section of larger outer diameter. The two sections are formed by the longitudinal ribs 70 and directly adjoin each other in the longitudinal direction so as to form a diameter jump 84. The diameter jump 84 lies in an imaginary transverse plane, wherein the guide surface 16, but not the fastening surface 18, is arranged on the one side of the transverse plane, and the fastening surface 18, but not the guide surface 16, is arranged on the other side of the transverse plane.

The longitudinal ribs 70 each have a radial length R, measured between the outer circumferential surface of the central mandrel 68 and the outer circumferential surface of the respective longitudinal rib 70. Each longitudinal rib 70 has a first radial length R1 in the section of the sealing body 12 of smaller outer diameter and a second radial length R2 in the section of the sealing body 12 of larger outer diameter.

The guide surface 16 bears in a guiding manner against the valve body 4. Via the fastening surface 18, the sealing body 12 is fastened in the armature 36, wherein the inner circumferential surface of the armature 36 and the fastening surface 18 bear directly against each other and form a press connection.

The sealing body 12 is located in the longitudinal passage 40 of the armature 36 and is completely arranged in the fluid channel 10. The sealing body 12 can therefore be flushed in the longitudinal direction on the outer circumferential side by fluid in the fluid channel 10.

The guide surface 16 is arranged upstream (with respect to the fluid direction F) of the fastening surface 18. The sealing body 12 protrudes with the guide surface 16 from the armature 36 on the end face.

The sealing body 12 has an approach-flow side 20 and a discharge side 21. The approach-flow side 20 faces the inlet opening 6, the discharge side 21 faces the outlet opening 8. On the approach-flow side, the sealing body 12 has four sections, which are arranged concentrically to one another and successively in the fluid direction F. The sections are formed by the central mandrel 68.

The sealing body 12 has a dynamic pressure reduction section 22, which has a tip and, starting from the latter, an outer diameter increasing in the fluid direction F. The dynamic pressure reduction section 22 is conical in the present case. The outer circumferential surface of the dynamic pressure reduction section 22 encloses a first angle W1 with the longitudinal axis A. The dynamic pressure reduction section 22 has a first length L1 and a largest diameter D1.

Subsequently in the fluid direction F, the sealing body 12 has a characteristic curve adjustment section 24, which is annular. In the present case, the characteristic curve adjustment section is convexly shaped and bulges out of the sealing body 12. In this case, the characteristic curve adjustment section 24 consists of three mutually directly adjacent linear curves. Between these adjacent linear curves, rounded sections can be formed, as viewed in longitudinal section. The linear curves are inclined differently with respect to the longitudinal axis.

A second angle W2 is enclosed by the dynamic pressure reduction section 22 and characteristic curve adjustment section 24. The outer circumferential surface of the characteristic curve adjustment section 24 encloses a third angle W3 with the longitudinal axis A. Downstream of this, the outer circumferential surface of the characteristic curve adjustment section 24 encloses a fourth angle W4 with the longitudinal axis A. The characteristic curve adjustment section 24 has a second length L2 and a largest diameter D2.

Subsequently in the fluid direction F, the sealing body 12 has a conical sealing section 26, which is annular and has an outer diameter increasing in the fluid direction F. In the closed position S1, the sealing section 26 bears against the sealing seat 80.

A fifth angle W5 is enclosed by the characteristic curve adjustment section 24 and the sealing section 26. The outer circumferential surface of the sealing section 26 encloses a sixth angle W6 with the longitudinal axis A. The sealing section 26 has a third length L3 and a largest diameter D3.

Subsequently in the fluid direction F, the sealing body 12 has a discharge section 28, which is annular and in parts has an outer diameter decreasing in the fluid direction F. The discharge section 28 is formed in two parts and has a cylinder section 28.1 arranged upstream and an outer diameter reduction section 28.2 arranged downstream. The longitudinal ribs 70 end upstream at the cylinder section 28.1. As viewed in longitudinal section, the outer circumferential surface of the cylinder section 28.1 runs parallel to the longitudinal axis A. The outer circumferential surface of the cylinder section 28.1 encloses an eighth angle W8 with the outer circumferential surface of the outer diameter reduction section 28.2. The outer circumferential surface of the outer diameter reduction section 28.2 encloses a ninth angle W9 with the longitudinal axis A. A seventh angle W7 is enclosed by the sealing section 26 and the discharge section 28. The discharge section 28 has a fourth length L4, wherein also the cylinder section 28.1 has a length L4.1 and the outer diameter reduction section 28.2 has a length L4.2. The discharge section 28 has a largest diameter D4, which is identical to the largest diameter D3.

The central mandrel 68 has a central base section 84, the outer circumferential surface of which, as viewed in longitudinal section, runs continuously parallel to the longitudinal axis A. The central base section 84 is arranged directly adjacent between the discharge section 28 and the nozzle needle 78. The central base section 84 has a fifth length L5 and a largest diameter D5.

A tenth angle W10 is enclosed by the discharge section 28 and central base section 84. An eleventh angle W11 is enclosed by the central base section 84 and the nozzle needle 78. The outer circumferential surface of the nozzle needle 78 encloses a twelfth angle W12 with the longitudinal axis A. The nozzle needle 78 has a sixth length L6 and a largest diameter D6, which is identical to the largest diameter D5. In relation to the longitudinal ribs 70, the nozzle needle 78 protrudes along the longitudinal axis A by a seventh length L7. The longitudinal ribs 70 have an eighth length L8. The sealing body 12/central mandrel 78 has a ninth length L9.

The side walls 88 of the longitudinal ribs 70 are aligned with the longitudinal axis A, in particular as shown in FIG. 2e. The longitudinal ribs 70 are distributed equidistantly in the circumferential direction U.

The invention is not restricted to any one of the embodiments described above and instead can be modified in a very wide variety of ways. All of the features and advantages apparent from the claims, the description and the drawing, including structural details, spatial arrangements and method steps, may be essential to the invention both individually and in a very wide variety of combinations.

The invention encompasses all combinations of at least two of the features disclosed in the description, the claims and/or the figures.

To avoid repetition, features disclosed in relation to a device are also considered, and can be claimed, to be disclosed in relation to a method. It is likewise the case that features disclosed in relation to a method are considered, and can be claimed, to be disclosed in relation to a device.

What is claimed is:

1. A flow control valve comprising:
a valve body having an inlet opening and an outlet opening on opposite sides of the valve body, and a fluid channel which fluidically connects the inlet opening to the outlet opening;
an electromagnet which is penetrated by the fluid channel; and
a sealing body which is adjustable between a closed position closing the fluid channel and an open position opening up the fluid channel.

2. The flow control valve according to claim 1, wherein the sealing body is arranged entirely in the fluid channel.

3. The flow control valve according to claim 1, wherein the sealing body is made of a plastic material or a metal.

4. The flow control valve according to claim 1, wherein the sealing body on its outer circumferential side forms at least one longitudinal channel.

5. The flow control valve according to claim 1, wherein the sealing body on its outer circumferential side has a guide surface and a fastening surface.

6. The flow control valve according to claim 5, wherein the sealing body has two sections of different outer diameter, wherein the guide surface is located on a first of the two sections having a smaller outer diameter and the fastening surface is located on a second the two sections having a larger outer diameter.

7. The flow control valve according to claim 1, wherein an approach-flow side of the sealing body has a dynamic pressure reduction section.

8. The flow control valve according to claim 1, wherein an approach-flow side of the sealing body has a characteristic curve adjustment section.

9. The flow control valve according to claim 8, wherein the characteristic curve adjustment section has a convex profile, a concave profile, a linear profile, or a combination thereof.

10. The flow control valve according to claim 1, wherein an approach-flow side of the sealing body has a sealing section.

11. The flow control valve according to claim 1, wherein an approach-flow side of the sealing body has a discharge section.

12. The flow control valve according to claim 1, wherein the sealing body has a nozzle needle on a discharge side of the sealing body.

13. The flow control valve of claim 1, further comprising:
a bearing ring; and
a preloading means supported against the bearing ring.

14. The flow control valve according to claim 1, wherein the electromagnet comprises an armature rod.

15. The flow control valve of claim 14, wherein the electromagnet is designed as a hollow part.

16. The flow control valve of claim 14, wherein the electromagnet has a wall thickness in a range of 0.2 mm to 0.4 mm.

17. The flow control valve according to claim 14, wherein the electromagnet has an armature on an inner circumferential side of the electromagnet, wherein the armature forms a fixing groove in which the armature rod engages.

18. The flow control valve according to claim 17, wherein an axial edge of the armature rod engages in the fixing groove so as to form a tapering inner diameter.

19. A method for mounting an armature rod, comprising:
providing an armature with a longitudinal passage and a fixing groove on an inner circumferential side of the armature;
providing an armature rod designed as a hollow part;
inserting the armature rod into the longitudinal passage from a first side of the armature;
inserting a deformation tool into the longitudinal passage from a second side of the armature; and
moulding the armature rod into the fixing groove by the deformation tool.
